(19) United States
(12) Patent Application Publication
(10) Pub. No.: US 2004/0242240 A1
(43) Pub. Date: Dec. 2, 2004

(54) Location assisted communications mode switching

(75) Inventor: Jyh-Han Lin, Coral Springs, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., SCHAUMBURG, IL

(21) Appl. No.: 10/445,694

(22) Filed: May 27, 2003

(51) Int. Cl. H04Q 7/20

(52) U.S. Cl. 455/456.3; 455/456.1

(57) ABSTRACT

Methods and devices are provided for automatically setting the communications mode of a wireless device based upon stored data defining the geographic coverage regions of a number or communications systems. In one method, there is received from a coverage server data describing a plurality of geographic regions and any communications modes available in each of the geographic regions. A present geographic location of the wireless communications device is determined, and the geographic region that contains the present geographic location is determined as a current region. The communications mode of the wireless communications device is set based upon the data describing the current region that is stored in the wireless communications device. Thus, the data can be centrally managed and updated at the coverage server. In preferred embodiments, the data includes many communications modes, including cellular and Wireless LAN modes.

### FIELD OF THE INVENTION

The present invention generally relates to the field of electronic equipment and more particularly relates to portable equipment that utilizes different modes based upon geographic location.

### BACKGROUND OF THE INVENTION

Portable electronic devices, such as cellular telephones, utilize multiple modes of communication. Cellular telephone modes are typically identified by the protocol used by that mode. Examples of protocols used by cellular phone services include the Advanced Mobile Phone Service (AMPS) protocol, several Code Division Multiple Access (CDMA) protocols, and the Global System for Mobile (GSM) protocol. There are variations of these protocols and each variation can be thought of as an operation “mode” for the communication device. In addition to these cellular telephone services, Wireless Local Area Networks (WLANs or Wireless LANs) are being widely deployed on a private and public basis. Examples of Wireless LANs include wireless network data communications via equipment that is compliant with the IEEE 802.11(b) standard. Corporations, for example, deploy their own Wireless LAN system in their office complexes so that their employees are able to communicate via such a wireless network. The use of the 802.11(b) standard allows the permanent deployment of publicly available Wireless LANs, such as in the vicinity of coffee shops and “Internet Cafes.” Wireless LANs can also be set up for shorter periods of time, such as in the vicinity of trade shows or other convention environments. Most Wireless LAN architectures include an authentication protocol and data encryption that allow for private use of the network, identification of authorized users and even billing for use of publicly available networks if that is desired by the network operator. It is common for several different cellular systems and/or Wireless LAN systems to have overlapping geographic coverage so that more than one of these wireless systems is available at a given location. Users of portable communications equipment frequently have a preference for which of these wireless systems to use based upon cost of use, available data rate or bandwidth, and other factors. In order to determine which systems are available at the current location of a portable communications device, it is common for the portable communication device to periodically scan for signals that identify the different wireless systems. This periodic scanning causes the portable communications device to consume energy and shortens battery life. This periodic scanning can also interfere with the operation of a communications device since receiver and possibly transmission circuits are redirected from communications to scanning functions.

Therefore a need exists to overcome the problems with the prior art as discussed above.

### SUMMARY OF THE INVENTION

One aspect of the present invention provides a method for setting a communications mode of a wireless communications device. According to the method, there is received from a coverage server data describing a plurality of geographic regions and any communications modes available in each of the geographic regions. The data received form the coverage server is stored in the wireless communications device. A present geographic location of the wireless communications device is determined, and the geographic region that contains the present geographic location is determined as a current region. The communications mode of the wireless communications device is set based upon the data describing the current region that is stored in the wireless communications device. In a preferred method, the data received from the coverage server includes relative priority information for the communications modes available in each of the geographic regions.

Another aspect of the present invention provides a wireless communications device that includes a coverage storage table, a geographic locator, a geographic region comparator, and a communications mode controller. The coverage storage table stores data describing a plurality of geographic regions and any communications modes available in each of the geographic regions, and the geographic locator determines a present geographic location of the wireless communications device. The geographic region comparator determines as a current region the geographic region that contains the present geographic location of the wireless communications device, and the communications mode controller sets a communications mode of the wireless communications device based upon the data describing the current region stored in the coverage storage table. In one preferred device, the communications modes include at least one cellular voice communications mode and at least one wireless LAN communications mode.

### BRIEF DESCRIPTION OF THE DRAWINGS

FIG. 1 is an exemplary map of geographic coverage for a number of wireless communications systems.

FIG. 2 is a block diagram of the components of a wireless communications system according to a preferred embodiment of the present invention.

FIG. 3 is a geographic coverage database as used by a preferred embodiment of the present invention.

FIG. 4 is a communications mode determination operational processing flow diagram for a wireless communications device, according to a preferred embodiment of the present invention.

FIG. 5 is an operating mode adjustment processing flow diagram, according to a preferred embodiment of the present invention.

### DETAILED DESCRIPTION

The present invention, according to a preferred embodiment, overcomes problems with the prior art by providing a wireless communications device, such as a voice and data capable wireless telephone, that has an integrated geographic locator such as a GPS receiver. This wireless communications device receives data specifying geographic coverage for a number of wireless communications systems, such as conventional cellular phone systems and Wireless LAN systems, and uses this coverage data to select one of the systems for wireless communications based upon the current location of the wireless communications device.

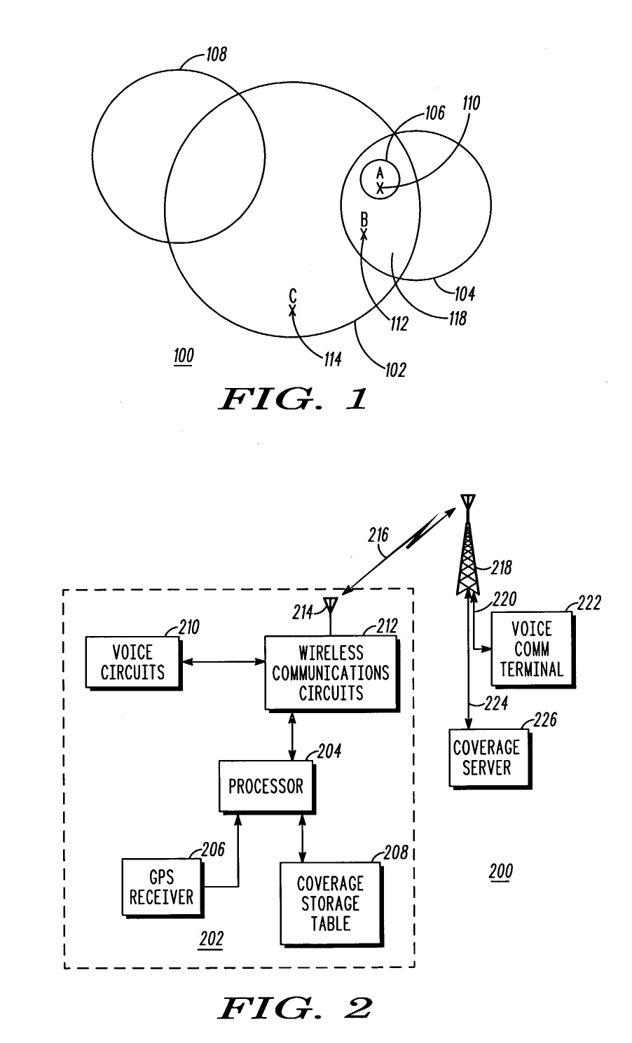

A coverage map 100 that shows exemplary geographic coverage areas for a number of wireless communications systems is illustrated in FIG. 1. The exemplary coverage map 100 shows four coverage areas that are each associated with different wireless communications systems. A first system has a first coverage area 102, a second system has a second coverage area 104, a third system has a third coverage area 106 and a fourth system has a fourth coverage area 108. This example uses circular coverage areas for simplicity and clarity of explanation and it is to be understood that deployed wireless communications systems are able to have more complex coverage areas that those illustrated. The various wireless communications systems in this example use different communications modes. Some different wireless communications systems utilize essentially the same communications protocol but use conventional techniques to allow the different systems to operate in the same region. In the description below, different services, such a different cellular telephone or Wireless LAN service providers, are described as using different communications modes even if they use essentially the same wireless protocol for communications.

In the exemplary coverage map 100, the first coverage area and the second coverage area 104 have a region of shared coverage 118. The third coverage area 106 is also shown to be wholly within the shared coverage area 118. The fourth coverage area 108 is shown to also have an area of shared coverage with the first coverage area 102. In this description, a “region” is described as a geographic area that is covered by the same set of modes, or wireless communications providers, that are relevant to the user of the wireless communications device. Other modes that may be available in a region but are not relevant to the user of the wireless communications device, such as private Wireless LANs to which the user does not have access, are not included in the definition of the communications modes within the regions.

The first, second and forth communications systems that are shown in the exemplary coverage map 100 have coverage areas that are consistent with conventional cellular telephone systems. For example, the first coverage area 102 can utilize a Motorola iDEN protocol, and the second coverage area 104 can utilize a GSM protocol. The third coverage 106 area can utilize a Wireless LAN protocol, such as the 802.11 (b) protocol. Although the third coverage area has a Wireless LAN protocol, communications devices in this area are able to use techniques such as Voice Over IP (VoIP) to perform voice communications using that protocol in this area. In the exemplary coverage area 100, the fourth coverage area 108 utilizes the AMPS protocol.

A wireless communications device that is within a coverage area for a communication system is able to use that communication system. When a wireless communications device is within a region that is serviced by two or more communications system, the wireless communications device is able to communicate by using any of those two or more systems serving that region. The exemplary coverage map 100 shows three exemplary geographic locations where a wireless communications device is able to be located. Location A 110 is shown to be located in a region that contains portions of three coverage areas, the first coverage area 102, the second coverage area 104 and the third coverage area 106. A wireless communications device located at location A 110 is able to use any of the first system, the second system or the third system for communications as the device is within the coverage area of all three of these systems. The preferred system in this case is dependent upon several factors; usually the least expensive, fastest and/or highest quality communications system is selected when multiple systems are available. The wireless communications device selects to use the operating communications mode that corresponds to this preferred system.

A second location, Location B 112, is shown in the exemplary coverage map 100 in a region 118 that includes portions of the first coverage area 102 and the second coverage area 104. This allows a wireless communications device at Location B 112 to use either the first system or the second system. A wireless communications device that was located at Location A 110 and that selected to use the third system with the third coverage area 106 is required to change to another communications system when it moves to Location B 112. The particular communications system that a wireless communications device selects to use at location B 112 is based upon similar criteria as were used for selecting at Location A 110. After the wireless communications device in this example crosses the boundary of the third geographic area 106, the wireless communications device is required to change to the preferred communication system as selected between the first and second communications system in this example.

A third location, Location C 114, is shown as only within the first coverage area 102. This requires a wireless communications device at Location C 114 to use the first communications system for communications at Location C 114. No selection of a communications system is performed at Location C 114 since only one communications mode is available. A wireless communications device located at Location B 112 and using the second communications system is required to change to the first communications system after it leaves the second coverage area 104, as would happen as the device is moving to Location C 114.

A block diagram 200 of the components of a wireless communications system according to a preferred embodiment of the present invention is illustrated in FIG. 2. Block diagram 200 illustrates a wireless communications device 202 that includes a processor 204, a GPS receiver 206, a coverage storage table 208, voice circuits 210 and wireless communications circuits 212 that use a communications antenna 214. The wireless communications circuits 212 in the exemplary embodiment include wireless transmitter and wireless receiver circuits. The wireless communications device 202 is in wireless communication with a communications tower 218 by a wireless link 216. The wireless communications tower of this example is coupled to a voice communications circuit 220 to complete a voice circuit between the wireless communications device 202 and a voice communications terminal 222. The wireless communications tower 218 is further coupled to a data communications link 224 to allow data communications between a coverage server 226 and the wireless communications device 202.

The exemplary embodiment shows voice communications between the user of the wireless communications device 202 and a voice communications terminal 222 for simplicity of explanation and understanding of the exemplary embodiments. The voice communications terminal of the exemplary embodiment is a conventional telephone terminal, although other voice terminals are able to be used. In addition to voice communications, the wireless communications device 202 can also be used for data communications to support data applications used by the user of the wireless communications device 202. In the exemplary embodiments, voice circuits 210 of the exemplary embodiment receive and produce audible signals for the user of the communications device 202 as is performed in conventional cellular telephones. These voice signals are processed and communicated by the wireless communications circuits 212 via antenna 214 as is also performed in conventional cellular telephones.

In addition to the user voice or user data communications performed by the wireless communications device 202, the exemplary embodiments of the present invention further communicate geographic coverage data for various wireless communications systems. A geographic coverage database is maintained in the coverage server 226 of the exemplary embodiment. The geographic coverage database is continuously maintained to reflect changes in the geographic coverage of various cellular communications system due to, for example, the addition and/or removal of base station towers. The geographic coverage database also includes data related to the geographic coverage of Wireless LAN systems and other communications systems used by the wireless communications device and that are relevant to the user of the wireless communications device. Wireless communications systems are relevant to the user, for example, if the user has access to the system through a subscription or some other authority or if the wireless communications system is available to any user.

Wireless LAN systems included in the geographic coverage database include public Wireless LAN systems that are accessible to subscribers if the user has a subscription or other access authority. Other included Wireless LAN systems include systems operated by the user's employer and which the user is authorized to use. The coverage database is also updated to reflect additions and cancellations of system operations, such as wireless LANs, that are set up on a temporary basis. Temporary wireless communications systems are set up, for example, at trade shows, convention centers and at other such transient events. The geographic coverage database is communicated from the coverage server 226 via the data communications link 224, wireless tower 218, wireless link 216, and the communications antenna 214 and the wireless communications circuits 212 of the wireless communications device 202. The wireless communications circuits extract the geographic coverage data from the wireless link 216 and provide that data to the processor 204. The processor 204 stores the geographic coverage data into the coverage storage table 208 that is contained within the wireless communications device 202 of the exemplary embodiment. For example, the table 208 is able to be stored in non-volatile memory, such as Flash ROM, within the device 202.

In embodiments of the present invention, the coverage server 226 can be implemented by a single server or by a “server cloud” that is made up of any number of servers. The individual servers of such a server cloud can be connected to one another and to a network such as the Internet in various ways and can even be separated by great distances so as to provide an appropriate level of service and advantageous features such as data and path redundancy.

A geographic locator, such as the GPS receiver 206 of the exemplary embodiment, determines the current location of the wireless communications device 202. The GPS receiver 206 of the exemplary embodiment provides the current location of the wireless communications device 202 to the processor 204, and the processor 204 compares this current location to the regions that are defined within the coverage storage table 208. The processor 204 of the exemplary embodiment performs a geographic region comparison, in a geographic region comparator, that determines if the coverage storage table 208, which is contained within the wireless communications device 202, contains a current region. A “current region” in this context is a region in which the current location lies. If there is no current region within the coverage storage table 208, the processor 204 requests an update of the geographic coverage database that contains data in the area of the current location of the wireless communications device 202.

The coverage storage table 208 of this exemplary embodiment stores a subset of the entire geographic coverage database that is maintained and stored in the coverage server 226. This allows the geographic coverage database to be managed on a central server by automated means, manual means or a combination of automated and manual means. The coverage server 226 is able to also be distributed among multiple servers to form a distributed database. Such a distributed database can be physically disposed so that geographical coverage information is stored in a sub-database server that is physically close to the geographic locations stored therein. Maintaining the database on a central server advantageously simplifies updating of the database with entries, for example containing temporary wireless communications services, such as Wireless LAN systems that are set up for a temporary time. This allows the database to be updated when knowledge of these temporary Wireless LAN systems is first known, and this information is communicated to the wireless communications devices as it is relevant.

The regions defined in the exemplary embodiment are particularized to the wireless communications system preferences of each user or group of users. Each user or group of users can have different preferences based upon wireless communications system subscriptions or accesses. An example of a group of users with the same preferences for wireless communications systems selection is a group of employees that are employed by the same company and that have company provided wireless communications devices.

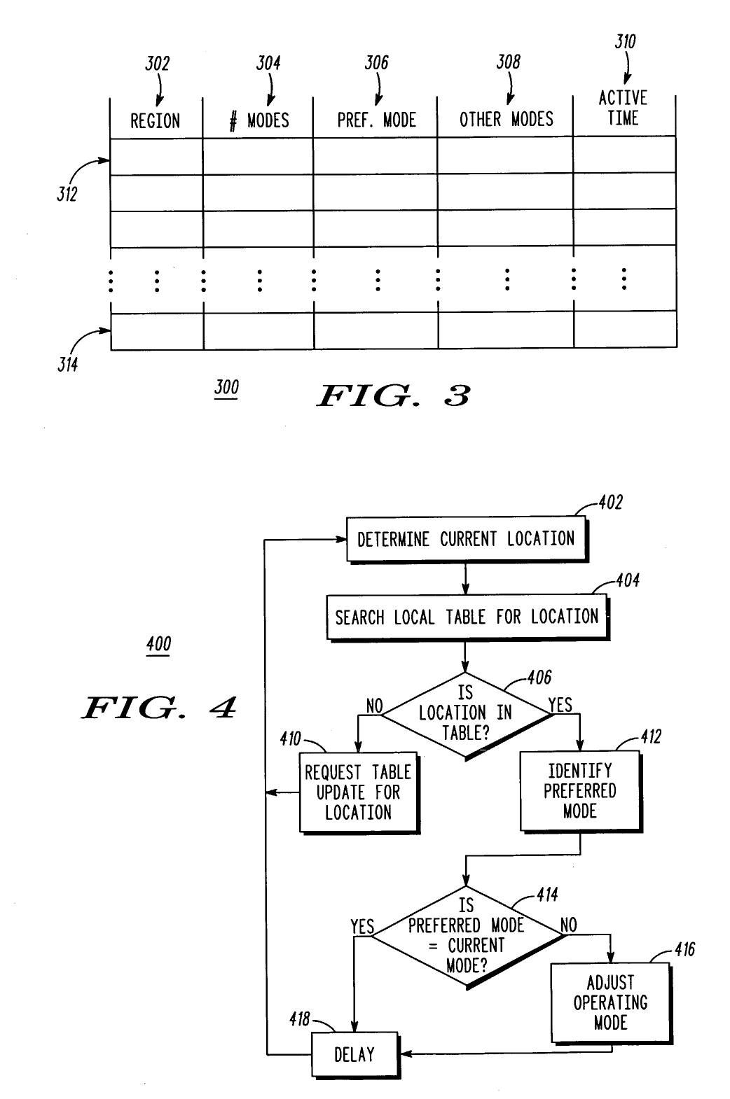

An exemplary geographic coverage database 300 as is used by the exemplary embodiment is illustrated in FIG. 3. The geographic coverage database 300 has a region column 302, a number of modes column 304, a preferred mode column 306, an “other modes” column 308 and an active time column 310. The geographic coverage database 300 has a row, such as first row 312 and last row 314, for each contiguous geographic region that has an available modes profile. The available modes profile describes the combination of wireless communications modes, such as modes associated with conventional cellular service, Wireless LAN services and other types of wireless services, that are available in that region. The region column 302 defines a region as a range according to the convention and requirements of the application. An example of a region specification stored in region column 302 is a circle with a center at a specified latitude and longitude and a specified radius. Other region area specifications can be squares, rectangles or other specifications that are suitable for a particular application.

The number of modes column 304 indicates the number of modes that are available in that region. A region is able to have a number of modes available, such as modes that utilize an iDEN protocol, an AMPS protocol, a GSM protocol and various Wireless LAN protocols, such as IEEE 802.11(b). The preferred mode 306 indicates the mode available in this region that is the preferred mode for use by this user, i.e., the first mode within the ordered priority of modes. The preferred mode is selected based upon a number of criteria, such as the cost of the service that is associated with that mode or speed of data transfers. The region definitions in the exemplary embodiments are personalized to each user or group of users with the same preferences. In further embodiments, the region definitions can be universal or personalized to any number of users in any manner.

The other modes column 308 contains an ordered list of the other modes, i.e., those below the preferred mode in the ordered priority, that are available within this region. The specification of other modes is ordered according to the preference that the user has for using those modes. The user preference is similarly determined by a variety of factors, such as cost and speed of data transfers. A communications device 202 determines the other mode to use when the preferred mode is not available by working its way down the ordered list of other modes that are specified in the other modes column. The preferred mode may not be available due to an outage of the system or due to radio path blockage, such as when operating inside of a building.

The active time column 310 indicates the time period during which the region data is valid. Region data can be valid for a specified time range if, for example, a temporary wireless communications mode will be available in that region. An example of region data that is valid for a specified time duration is a region that contains a temporary Wireless LAN system, such as a Wireless LAN system that is installed in a convention center to support a trade show or other event. The active time column 310 can specify that a region is valid for all time, as is set for a region with only permanently operating wireless communications systems.

Alternative embodiments of the present invention store in the wireless communications device data in the form of region definitions and the modes that are available in each of those regions. Some of these embodiments store coverage information that has uniformly sized regions. Regions in these embodiments are able to be specified as, for example, one city block or as a square with sides of one tenth of a mile. The use of uniformly sized regions advantageously simplifies region calculations. Further, some embodiments of the present invention perform processing within the wireless communications device to determine which mode to use within the current region. Such embodiments can be configured with mode priority information from other sources and are able to be configured with this priority information through, for example, separately communicated data or manually entered data. For example, in one embodiment, the stored data just lists all of the available modes for each region, and then user-entered (or group programmed) mode preferences are used to select a mode from the available modes in the current region. This allows each user (or group administrator) to select preferred modes, and even to prevent use of some modes, based on personal preferences.

A communications mode determination operational processing flow 400 for a wireless communications device according to an exemplary embodiment of the present invention is illustrated in FIG. 4. The processing performed by the wireless communications device 202 begins by determining, at step 402, the location of the wireless communications device. The exemplary embodiment determines location through the use of a GPS receiver 206 that is incorporated into the wireless communications device 202. Further embodiments of the present invention utilize other geographic locators that are either incorporated into the wireless communications device or that are external to the wireless communications device and relay the geographic location back to the wireless communications device. An example of an external geographic location device is a location system that monitors wireless device transmissions at a number of sites and performs direction finding, time difference of arrival (TDOA) or other processing to determine the location of the transmitting wireless communications device and then relays the location back to the wireless communications device.

After the location of the device is determined, the processing advances by searching, at step 404, the geographic coverage table data that is stored in the coverage storage table 208 within the wireless communications device 202. The geographic coverage table data that is stored in the coverage storage table 208 within the wireless communications device 202 of the exemplary embodiment contains a subset of the entire geographic coverage database that is stored at the coverage server 226 of the exemplary embodiment. The storage of a subset of the entire geographic coverage database in the wireless communications device reduces the storage requirements of the wireless communications device and allows for a more efficient and cost effective design of the portable device. For example, some embodiments store subsets based on ZIP or postal codes, or state or county or other geographical or political boundaries and communicate the geographic coverage subset data for these areas is preferably communicated to the wireless communications device as it enters or approaches those areas.

The processing next determines, at step 406, whether the current location of the wireless communications device 202 is within the regions that are contained within the local coverage storage table 208. The exemplary embodiments only check to see if the current location is within a region if that region definition has an active time value, contained in the active time column 310, that includes the current time. Regions with active times that do not include the current time are not checked. If the current location is not located within a region contained within the local coverage storage table 208, the processing continues by the geographic region comparator, which is performed by processing within processor 204, requesting, at step 410, a subset update from the coverage server 226. This request is generated by the processor 204, communicated via the wireless communications circuits 212 through the communications antenna 214, wireless link 216 and data link 224 to the coverage server 226. The coverage server 226 then determines a subset of the geographic coverage database that corresponds to the current location of the wireless communications device 202 and communicates that subset back to the wireless communications device 202 over the same path used to communicate the request in the exemplary embodiment.

In an alternative embodiment, the location of the wireless communications device 202 and is tracked and the coverage server 226 is aware of the data currently stored in the wireless communications device. For example, the location of the wireless device can be determined by the coverage server 226 (roughly based upon the base station with which the wireless communication device is communicating or more precisely using known algorithms such as triangulation), or location data can be sent from the wireless communications device 202 to the coverage server 226. Further, the coverage server 226 can store information regarding the currently stored data for each wireless communication device 202 and then update this data each time a data update is sent to a wireless communication device 202. Alternatively, the wireless communication device can send information regarding its currently stored data to the coverage server 226 at the occurrence of an event (such as power on or transferring to another base station) and/or at some periodic or other interval, so as to eliminate the need to permanently store such information for all wireless communications devices. These are just illustrative embodiments, and the location and currently stored data is determined in other manners in further embodiments of the present invention.

In embodiments in which the location of the wireless communications device is tracked by the coverage server, as soon as or some time after the wireless communications device is registered in a region that is not contained within the local coverage storage table 208, the coverage server 226 pushes a subset update to the wireless communications device 202. Preferably, the coverage server 226 only pushes the data (or the differences) in the current region to the wireless communications device. Thus, data updates are pushed to wireless communications devices to allow the necessary updates to be performed in a very efficient manner, and to decrease the additional processing requirements on the wireless communications device.

Returning to the processing flow of FIG. 4, if the current location is located within a region that is contained within the local storage coverage table 208, then the processing advances to identifying, at step 412, the preferred mode for wireless communications within the identified region. The preferred mode for the region in which the current location is located is defined by the data within the preferred mode column 306 in the exemplary embodiment. Alternative embodiments that store region and available mode information in the coverage storage table 208, but that do not contain mode preference data within the coverage storage table 208, determine the preferred mode according to the processing of the specific embodiment, as explained above.

The processing then determines, at step 414, if the preferred mode is the current mode operating mode for the wireless communications device 202. If the wireless communications device is operating in the preferred mode for the current region, the processing of the exemplary embodiment then delays, at step 418, for a period. The delay in this processing loop is included to reduce the energy and processing power consumption used by the wireless communications device in performing this processing. The length of the delay is selected based upon several criteria, such as the expected maximum velocity of the wireless communications device, and therefore duration in which the device is expected to remain in a region. The length of the delay can also be based upon other factors used to determine system operating mode changes in conventional wireless communications systems.

If the preferred mode is not the current operating mode, the processing of the processor 204, which is the communications mode controller in the exemplary embodiment, adjusts, at step 416, the operating mode of the wireless communications device, as is described below. After this adjustment, the processing executes the delay 418 described above and returns to determining, at step 402, the current location of the wireless communications device 202.

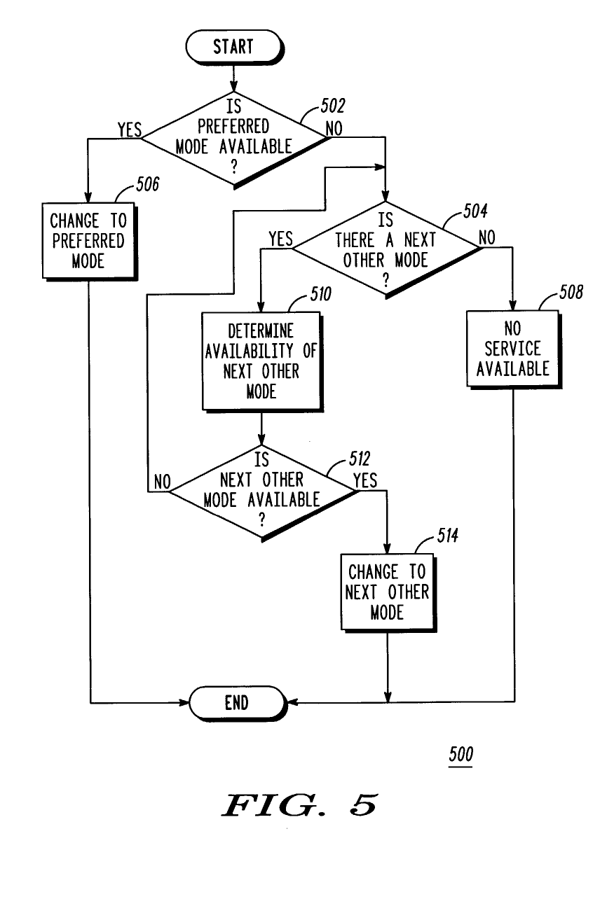

An operating mode adjustment processing flow diagram 500 for a wireless communications device according to a preferred embodiment of the present invention is illustrated in FIG. 5. The operating mode adjustment processing begins by determining, at step 502, if the preferred operating mode, as is specified by the data in the preferred mode column 306, for the region containing the current location of the wireless communications device is available. This determination in the exemplary embodiment is performed through conventional methods that include receiving a transmission from a base station that identifies the availability of that communications mode and service. A determination of the availability of a particular mode may also include signal strength and/or other signal quality measurements. If the preferred mode is determined to be available, the processing changes, at step 506, the operating mode of the wireless communications device 202 to the preferred mode. The processing for this function then terminates.

If the preferred mode was determined to not be available, the processing advances to determine, at step 504, if there is a “next” other mode stored in the other modes column 308 for the current region. For the first iteration of trying the other modes, the “next” other mode is the first other mode in the ordered list of other modes specified in the other modes column 308. If there is not a next other mode stored in the other modes column, the processing advances to declare, at step 508, that no wireless communications modes are available. The processing for this function then terminates.

If a next other mode is specified in the other mode column for the current region, the processing advances to determine, at step 510, if this next other mode is available. This determination is performed by conventional means for that particular operating mode and its associated wireless communications service. The processing next decides, at step 512, the next stage of processing to perform dependent upon whether the next other mode is available. If this other mode is not available, the processing returns to determining, at step 504, if there is another “next” other mode specified in the other modes column 308.

If the processing determines that this other mode is available, the processing advances to change, at step 514, the operating mode to this other operating mode. The processing for this function then terminates.

Preferred embodiments of the present invention utilize wireless communications devices that monitor their location and velocity to anticipate when the device will enter into a new region, i.e., cross the boundary between the current region and a next region. These embodiments are able to determine if region data for adjacent regions is stored within the coverage storage table 208 that is within the wireless communications device. If adjacent region data is not stored within the coverage storage table 208, the device requests an update from a remote coverage server 226 to receive the region data for the adjacent regions into which the wireless communications device is about to enter. Some embodiments are able to provide a “push” mode of operation where the coverage server 226 automatically transmits new coverage data based upon the region that the wireless communications device is in as determined, for example, by the base station with which the wireless communications device is communicating. The powering up of a wireless communications device in a new region also initiates this download of new region data in some embodiments.

One embodiment of the present invention is configured to determine when a wireless communications device is approaching a Wireless LAN “hotspot” located at the user's home or workplace. A Wireless LAN hotspot is a relatively localized region that is serviced by one or more wireless LAN base stations and in which a wireless communications device is able to, and has the proper permissions to, communicate via the one or more wireless LAN base stations. This determination is preferably made based on a GPS receiver contained within the wireless communications device. Thus, the wireless communications device can be automatically configured to switch over from a cellular telephone service to use this Wireless LAN hotspot for communications when within the hotspot coverage region.

The exemplary embodiments of the present invention advantageously use geographic location data to ensure that a multiple mode wireless communications device is using the preferred communications mode for the region in which it is located. These embodiments provide an advantage over the prior art by minimizing scanning of the various communications modes that are currently available to the wireless communications device. This reduces power consumption that would otherwise be used to perform this periodic scanning to determine which communications modes, and therefore which communications systems, are available at the wireless communications device's current geographic location. These embodiments also advantageously manage, maintain and support the geographic coverage databases on a remote server that can be centrally administered and distributed among various geographic locations. Central administration of the coverage server allows more timely and efficient updates and improves the “freshness” of the coverage database that includes temporary coverage areas, such as temporary Wireless LAN systems. The use of remote servers also allows the wireless communications device to store only that portion of the coverage database that is necessary for immediate use so that a smaller amount of data can be stored in the wireless communications device. This reduces hardware costs for the device.

Although the exemplary embodiments utilize wireless communications devices, it is to be understood that the scope of the present invention includes applications that use any type of geographically based mode switching.

The present invention can be realized in hardware, software, or a combination of hardware and software. A system according to a preferred embodiment of the present invention can be realized in a centralized fashion in one programmable processor, or in a distributed fashion where different elements are spread across several interconnected processors. Any kind of programmable processor—or other apparatus adapted for carrying out the methods described herein—is suited. A typical combination of hardware and software could be a general purpose processor with a computer program that, when being loaded and executed, controls the processor such that it carries out the methods described herein.

The present invention can also be embedded in a computer program product, which comprises all the features enabling the implementation of the methods described herein, and which—when loaded in an information processing system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each information processing system may include, inter alia, one or more devices and at least a computer (or machine) readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for setting a communications mode of a wireless communications device, the method comprising:
receiving from a coverage server data describing a plurality of geographic regions and any communications modes available in each of the geographic regions;
storing in a wireless communications device the data received form the coverage server;
determining a present geographic location of the wireless communications device;
determining as a current region the geographic region that contains the present geographic location of the wireless communications device; and
setting the communications mode of the wireless communications device based upon the data describing the current region that is stored in the wireless communications device.

2. The method according to claim 1, wherein the data received from the coverage server includes relative priority information for the communications modes available in each of the geographic regions.

3. The method according to claim 1, wherein the communications modes include at least one cellular voice communications mode and at least one wireless LAN communications mode.

4. The method according to claim 1, further comprising:
if the data stored in the wireless communications device does not include data describing the current region, requesting data describing at least the current region from the coverage server.

5. The method according to claim 1, further comprising:
receiving from the coverage server a data update including data describing at least one geographic region and any communications modes available in the at least one geographic region.

6. The method according to claim 5, wherein the data update is automatically received by the wireless communications device when the wireless communications device enters a different geographic region.

7. The method according to claim 5, wherein the data update is automatically received by the wireless communications device when the wireless communications device powers on.

8. A wireless communications device comprising:
a coverage storage table for storing data describing a plurality of geographic regions and any communications modes available in each of the geographic regions;
a geographic locator for determining a present geographic location of the wireless communications device;
a geographic region comparator for determining as a current region the geographic region that contains the present geographic location of the wireless communications device; and
a communications mode controller for setting a communications mode of the wireless communications device based upon the data describing the current region stored in the coverage storage table.

9. The wireless communications device according to claim 8, wherein the data stored in the coverage storage table includes relative priority information for the communications modes available in each of the geographic regions.

10. The wireless communications device according to claim 8, wherein the communications modes include at least one cellular voice communications mode and at least one wireless LAN communications mode.

11. The method according to claim 8,
wherein the coverage storage table stores a subset of the data for all geographic regions, and
if the data stored in the coverage storage table does not include the data describing the current region, the geographic region comparator requests at least the data describing the current region from a coverage server.

12. The wireless communications device according to claim 8,
wherein the coverage storage table stores a subset of the data for all geographic regions, and
the wireless communication device further includes a receiver for receiving from a coverage server a data update including the data describing at least one geographic region and any communications modes available in the at least one geographic region.

13. A computer program product for setting a communications mode of a wireless communications device, the computer program product comprising instructions for performing the steps of:
receiving from a coverage server data describing a plurality of geographic regions and any communications modes available in each of the geographic regions;
storing in a wireless communications device the data received form the coverage server;
determining a present geographic location of the wireless communications device;
determining as a current region the geographic region that contains the present geographic location of the wireless communications device; and
setting the communications mode of the wireless communications device based upon the data describing the current region that is stored in the wireless communications device.

14. The computer program product according to claim 13, wherein the data received from the coverage server includes relative priority information for the communications modes available in each of the geographic regions.

15. The computer program product according to claim 13, wherein the communications modes include at least one cellular voice communications mode and at least one wireless LAN communications mode.

16. The computer program product according to claim 13, further comprising instructions for performing the step of:
if the data stored in the wireless communications device does not include data describing the current region, requesting data describing at least the current region from the coverage server.

17. The computer program product according to claim 13, further comprising instructions for performing the step of:
receiving from the coverage server a data update including data describing at least one geographic region and any communications modes available in the at least one geographic region.

18. The computer program product according to claim 17, wherein the data update is automatically received by the wireless communications device when the wireless communications device enters a different geographic region.

19. The computer program product according to claim 17, wherein the data update is automatically received by the wireless communications device when the wireless communications device powers on.

20. A wireless communications system comprising:
a coverage server for storing data describing a plurality of geographic regions and any communications modes available in each of the geographic regions; and
a transmitter for transmitting to a plurality of wireless communications devices subsets of the data stored on the coverage server.

21. The wireless communications system according to claim 20, further comprising a receiver for receiving from the wireless communications devices requests for subsets of the data stored on the coverage server.
